(19) United States
(12) Patent Application Publication
(10) Pub. No.: US 2021/0031122 A1
(43) Pub. Date: Feb. 4, 2021

(54) Method for Separating Cesium and Technetium

(71) Applicant: KERNTECHNISCHE ENTSORGUNG KARLSRUHE GMBH, Eggenstein-Leopoldshafen (DE)

(72) Inventors: Franz Strohmer, Eggenstein-Leopoidshafen (DE); Marco Klipfei, Eggenstein-Leopoidshafen (DE); Sebastian Bahl, Eggenstein-Leopoldshafen (DE)

(21) Appl. No.: 16/967,014

(22) PCT Filed: Feb. 5, 2019
(86) PCT No.: PCT/EP2019/052701

§ 371 Date: Aug. 3, 2020

(30) Foreign Application Priority Data
Feb. 5, 2018 (DE) 10 2018 102 510.6

(51) Int. Cl. B01D 7/00; G21F 9/30; G21F 9/02; C01G 1/02; C01D 17/00

(52) U.S. Cl. CPC B01D 7/00; G21F 9/30; C01D 17/00; C01G 1/02; G21F 9/02

(57) ABSTRACT

The present invention relates to a method for separating cesium and technetium from radioactive waste, which method comprises the sublimation of cesium pertechnetate, and an apparatus for carrying out this method. The separation includes the steps of obtaining the two elements cesium and technetium together from the waste and subsequently separating the two elements from each other. The aim of the present invention is to significantly reduce the activity of radioactive solid waste and to use the obtained radionuclides in an economical and technical manner. Additionally, the method allows elements of cesium and technetium to be separated directly from the operation of a vitrification, sintering, drying, combustion, cementing, or calcinating plant, thus obviating additional problems when carrying out the process.

The present invention relates to a method for separating cesium and technetium from mixtures of radioactive substances and to a device for carrying out the method.

### PRIOR ART

When spent fuel elements from reactors for civil or military use are reprocessed, solutions of highly radioactive waste occur (High Active Waste Concentrate, HAWC; High-Level Waste, HLW or HLLW and HAW), these solutions containing fission products, generally dissolved in nitric acid solution. According to the current prior art, one way of conditioning this waste in a form suitable for final disposition is to integrate it safely in a glass matrix (vitrification). The waste, in a concentrated form, is poured into molten glass and then safely immobilized in the waste glass created. Stored in stainless steel canisters, in this form the highly radioactive waste is suitable for final disposition in deep geological rock formations.

The short-lived and gaseous fission products with half-lives of less than one year (e.g. iodine-131) play almost no role in the final disposition and radioactive activity, since these nuclides have completely decomposed or outgassed during the reprocessing and storage period. The very long-lived nuclides with half-lives of more than 10,000 years, such as technetium-99 (Tc-99, 211,500 year half-life) necessitate safe long-term containment of the glass molds in the repository, as their radioactivity decays only slowly. However, their contribution to the total radioactivity of the HAWC solution and the molds is minor, since these nuclides only decay at low decay rates. In contrast, of crucial importance are the nuclides cesium-137 (Cs-137) and strontium-90 (Sr-90); with half-lives of 30 years and 28.9 years, respectively, they decay relatively rapidly, and therefore make a critical contribution to the total radioactivity of the HAWC solution and glass molds.

The nuclides of cesium (that is, e.g., Cs-137, Cs-133, Cs-134, Cs-135) also have the property, under certain conditions, of forming cesium pertechnetate (CsTcO₄) together with the fission product Tc-99. This happens primarily in reprocessing plants under oxidizing conditions in solutions with nitric acid. However, cesium pertechnetate is considered to be extremely problematic with respect to final disposition due to its high water solubility as well as its high volatility in steam. It also has strong oxidizing properties and high thermal volatility. It has been observed that, for example, when the HAWC solution is metered into it, cesium pertechnetate undesirably volatilizes out of the glass melt during the vitrification process and is deposited in cold areas of the exhaust system and thus partially clogs the latter. Attempts are therefore generally made to prevent the formation of cesium pertechnetate in the vitrification plant.

The problem of the cesium pertechnetate deposited in the vitrification plant has so far regularly been countered by removing, either mechanically or by dissolving with water/acid, the cesium pertechnetate formed during the vitrification of HAWC solutions, e.g., at glass melt temperatures of greater than 600° C., and deposited in the exhaust system, and thus the escaped cesium and technetium nuclides are returned to the vitrification process. However, these measures often produce unsatisfactory results and their effectiveness is usually short-lived.

However, re-metering these solutions or solids with an increased cesium pertechnetate content does not solve the problem in a sustainable manner, since increased deposits in the exhaust system of the vitrification plant also result due to high volatility with an elevated added cesium concentration. In most vitrification plants, continuous vitrification operation therefore leads to long-term accumulation of cesium in the exhaust system. It is assumed that on average approx. 15% of the cesium inventory and at least as much of the technetium-99 inventory is not added to the glass product. In principle, this technical problem exists with all HAWC vitrification plants worldwide. In addition, pertechnetates (i.e., technetium compounds in oxidation state VII) are also quite problematic in the finished glass of the mold. That is, in contrast to lower oxidation states (e.g. in oxidation state IV for TcO₂), they are easily leached out of the solidified glass melt with water.

DE 26 09 223 describes a process for producing aqueous solutions of radioactive pertechnetate. Technetium is separated from molybdenum-99 via a column, however, no mention is made of cesium.

WO 97/37995 describes a method for separating pertechnetate from radioactive waste. However, the separation is effected using complexing agents such as calixpyrroles and other macrocycles.

WO 01/95342 relates to a method for treating radioactive waste, which method includes the reduction of oxidic technetium compounds with hydrazine. However, the document does not describe the separation of cesium and technetium, let alone the sublimation of cesium pertechnetate.

U.S. Pat. No. 5,185,104 describes a method for treating radioactive waste at temperatures between 500° C. and 3000° C. Various oxidic substances are fractionated using vacuum distillation. The sublimation of cesium pertechnetate is not described, nor is the separation of cesium and technetium nuclides via the isolated cesium pertechnetate.

There is therefore still a need for improved conditioning and final disposition of radioactive waste, which reliably overcomes the problems mentioned above.

The underlying object of the present invention is therefore to provide an improved method for reprocessing radioactive waste material.

This object was surprisingly achieved using the method according to the invention and the device according to the invention in accordance with the claims below. The device is preferably suitable for carrying out the method and is adapted accordingly thereto.

Surprisingly, it was found that ideal complete separation of the cesium and technetium nuclides from radioactive waste allows improved final disposition of the residual waste. It was also surprisingly found that the separated nuclides can be reused in various technical fields, for example as a source of radiation in medical technology and as neutron barriers.

### FIGURES

FIG. 1 depicts a gas cooling unit of three gas coolers connected in series according to one preferred embodiment of the invention.

FIG. 2 depicts a particularly preferred gas cooler arrangement according to the present invention that contains two gas cooling units, each of which has three gas coolers (cooling zones) connected in series. The two gas cooling units are connected in parallel such that they are used alternately a) for depositing cesium pertechnetate from the exhaust gas flow and b) for obtaining the deposited cesium pertechnetate, thus permitting continuous operation, e.g., in the exhaust gas flow of a vitrification device.

FIG. 3 depicts a vessel that can be used for separating cesium pertechnetate from dry residues from the reprocessing of nuclear fuels or from the vitrification process and other drying residues from HAWC solutions or other solids provided with blasting agents according to one preferred embodiment of the present invention.

### DESCRIPTION OF THE INVENTION

The invention provides an improved method for separating cesium isotopes (in particular cesium-137) and technetium isotopes (in particular technetium-99) from the exhaust gas flow from nuclear vitrification plants or from reprocessing plants and residues of such plants in which radioactive waste and in particular HAWC solutions are processed and prepared for final disposition or are used for technical purposes. The aim of the method according to the invention is to effectively reduce the waste activity to be disposed of, to obtain the separated nuclides, and to use them economically and technically.

The phrase “separation of cesium and technetium” from radioactive waste encompasses both obtaining the two nuclides together from the waste (isolation as cesium pertechnetate) and the preferred subsequent separation of the two elements from one another (isolation of the separated elements). Alternatively, the method can also be referred to as a method for obtaining cesium and technetium from radioactive waste, wherein the substance obtained can be in the form of cesium pertechnetate or in the form of the two separate elements, cesium and technetium. If the two elements are obtained separately, they are ultimately preferably present as the solids technetium dioxide and cesium salt (preferably CsCl or Cs₂SO₄), which can be reused, for example, in medical technology. In any case, it is essential to the invention that the method comprises the targeted sublimation of cesium pertechnetate (CsTcO₄) (i.e. sustainably separating or obtaining the two elements from radioactive waste using sublimation).

One essential step of the method according to the invention is obtaining cesium pertechnetate by means of sublimation (step 1).

According to the invention, this sublimation can either occur directly in the exhaust gas flow of a reprocessing plant or from solid residues (e.g. in dry, paste, or moist form) from the reprocessing of nuclear fuels or from the vitrification process and other solid residues from HAWC solutions or other solids, even if these are present in the mixture with other substances or in a moist state. Suitable reprocessing plants for mixtures of radioactive substances according to the invention are selected, for example, from (conventional) vitrification plants, sintering plants, drying plants, combustion plants, cementing plants and calcinating plants. When carried out, e.g., in the vitrification plant, the cesium pertechnetate from the exhaust gas flow is deposited by means of suitable cooling measures using consolidation (depositing from the gas phase) and is then separated off. Performing this method in other processing plants takes place correspondingly. If dry residues are used, they are heated in a suitable vessel (preferably under reduced pressure), the sublimated cesium pertechnetate reconsolidates on cool surfaces (deposited from the gas phase), and is then separated off therefrom. In both cases, the cesium pertechnetate deposits as a very pure solid that can be easily obtained.

If the sublimation is carried out directly in the exhaust gas flow of a vitrification plant, i.e., the method according to the invention is included in a vitrification method, it is preferred to remove the cesium pertechnetate present in the hot exhaust gas flow (preferably at ambient pressure, but at reduced pressure is also possible) by means of gas coolers connected downstream of the exhaust gas flow. For this purpose, the hot vitrification exhaust gases are preferably conducted in the air flow over the cooling coils (also known as “cooling fingers”) of the gas coolers, the cesium pertechnetate diffusing in the exhaust gas flow and entering the gas coolers, depositing there in a chemically pure crystalline form. Gas coolers can be connected in series (e.g. as multi-stage exhaust gas coolers or gas cooling units) or in parallel, which further increases the efficiency of the cesium pertechnetate separation.

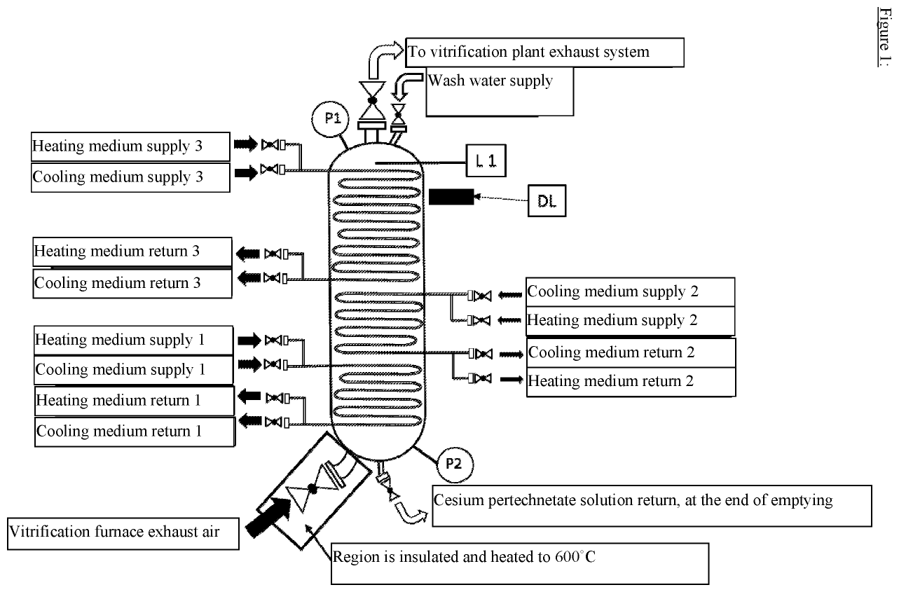

One preferred method includes using gas cooling units with two, three, four, five, or more gas coolers connected in series. Particularly preferred is using gas cooling units with three gas coolers, corresponding to three cooling zones connected in series. Such a gas cooling unit is shown in FIG. 1. The use of two, three or four (preferably two) such gas cooling units connected in parallel with one another is very particularly preferred. Temperature control of the zones strongly depends on the vitrification process and vitrification plant. In one preferred embodiment, the temperature of the cooling zones ranges from approximately 600° C. in the inlet region to approximately 250° C. in the outlet region of the gas cooler.

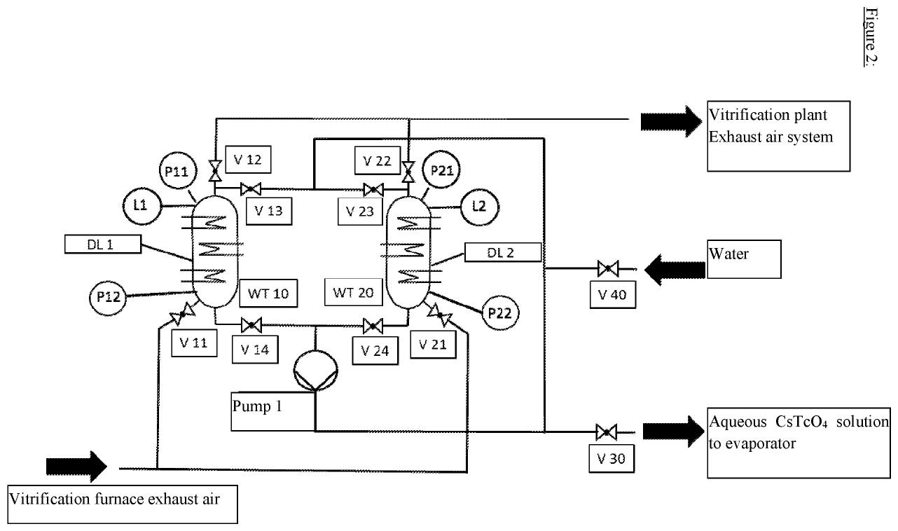

The most preferred method includes using two gas cooling units, each of which has three gas coolers (cooling zones) connected in series, the two gas cooling units being connected in parallel such that they are alternately used a) to deposit cesium pertechnetate from the exhaust gas flow and b) to obtain the deposited cesium pertechnetate, and thus they permit continuous operation. “Alternating” is to be construed to mean that cesium pertechnetate from the exhaust gas flow is deposited in one of the two gas cooling units per time unit, while the cesium pertechnetate previously deposited in the other gas cooling unit is obtained there. After cleaning, the task of the two units is reversed, so that the method is carried out continuously overall without downtimes caused by obtaining/cleaning all of the cooling units. Such a particularly preferred method is shown in FIG. 2.

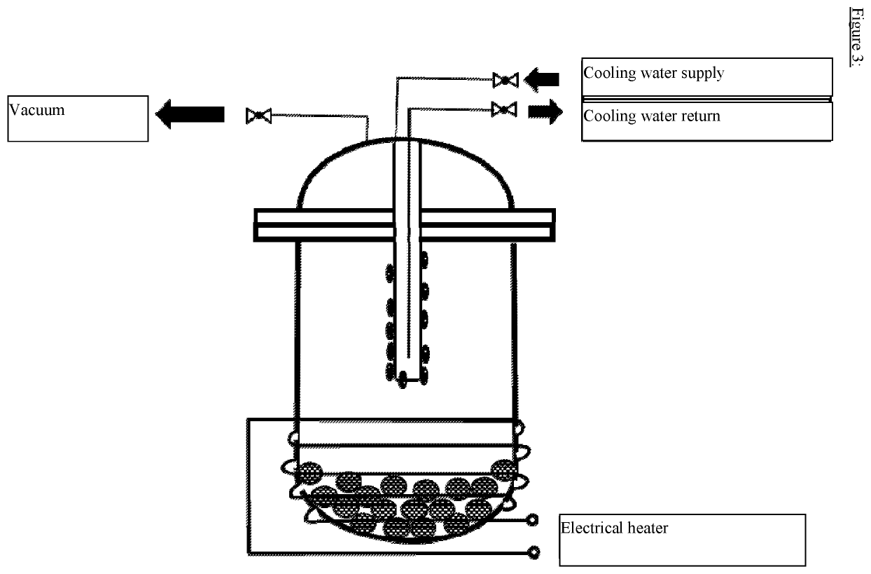

As an alternative to the vitrification furnace, the method according to the invention can also be used with residues from the reprocessing of nuclear fuels or from other reprocessing methods (e.g., sintering, etc.), as well as with general residues from HAWC solutions or other solids present in the mixture and containing cesium pertechnetate. In this case, the residues are preferably collected in a vessel (e.g. boiler), the CsTcO₄ is converted to the gas phase by heating at a suitable temperature (and preferably under reduced pressure), and is deposited in a form similar to that in the embodiment in the exhaust gas flow of the vitrification furnace on cooled gas cooler surfaces or cooling fingers. A suitable vessel is shown in FIG. 3.

The temperature used is preferably in a range of less than 500° C., preferably in a range from 100° C. to 500° C., particularly preferably from 150° C. to 450° C., and very particularly preferably from 300° C. to 400° C. A reduced pressure is preferably applied, e.g. in the range from 10⁻⁸ to 10⁻¹⁹ bar, preferably from 10⁻⁹ to 10⁻¹⁹ bar. This significantly lowers the sublimation temperature of cesium pertechnetate, making the process quicker, easier, and more economical.

According to the invention, the method can be carried out such that either the deposited cesium pertechnetate is separated from the vessel used in situ (i.e. from the cooling fingers/cooling coils), or the part of the vessel used at which the cesium pertechnetate has deposited (i.e. cooling fingers/cooling coils) is removed from the vessel before the cesium pertechnetate is separated and is transported to another suitable location, where the cesium pertechnetate is then separated off and obtained. The separation can be accomplished in both cases using mechanical removal or by rinsing with a suitable solvent or water. This results in even more efficient and economical separation from the residual waste.

The pure cesium pertechnetate deposited according to any of the above-mentioned embodiments of the method according to the invention is preferably separated by dissolving with an inorganic or organic solvent comprising water. Suitable inorganic solvents are liquid ammonia and carbon dioxide. Suitable organic solvents are inert solvents, such as halogenated hydrocarbons. Pure water is preferably used. The basis for this is the solubility of the cesium pertechnetate in water of 8.79 g/l at 40° C. The temperature of the solvent is preferably 20° C. to 60° C., preferably 30° C. to 50° C. (step 2). The gas coolers (i.e. cooling fingers) can then be reused for the separating process.

In this way an aqueous cesium pertechnetate solution is obtained that can undergo further processing. Alternatively, the separated cesium pertechnetate is not isolated as an aqueous cesium pertechnetate solution, but instead further processing with the separated cesium pertechnetate takes place directly (e.g. on the cooling finger).

The preferably performed processing of the cesium pertechnetate according to the present invention comprises the two optional steps below (step 3 and step 4). Technetium is chemically separated from cesium in step 3, which is preferably carried out according to the present invention. For this purpose, cesium pertechnetate is reduced either in aqueous solution or in non-aqueous solution (preferably in aqueous solution), in which reduction the pertechnetate is converted to technetium dioxide (TcO₂.1-2 H₂O), which precipitates out of the solution as a solid while cesium remains in aqueous solution. Suitable reducing agents are in principle all substances that are able to reduce pertechnetate, such as, e.g., LiAlH₄, NaBH₄, and alkali metal hydrides. Particularly suitable are reducing agents whose products do not introduce any additional elements into the solution following the reaction, such as hydrazine, carbon monoxide, and organic reducing agents such as formaldehyde, acetaldehyde, formic acid, oxalic acid. Hydrazine is particularly preferred.

The technetium dioxide precipitated as a solid can then be separated off, preferably by filtration. After the filtrate has been neutralized (e.g. with sulfuric acid or hydrochloric acid), cesium is present in the aqueous phase as a dissolved cesium salt (e.g. as cesium sulfate or cesium chloride). In this way, cesium and technetium are efficiently separated using the wet chemical method. Cesium-technetium separations based on extractions from the aqueous phase with organic solvents are conventionally carried out using tri-n-octylphosphorus oxide in cyclohexanone. However, these reactions always require additional separation of the solvent or re-extraction of the organic phase with an aqueous solution in order to return the technetium to the aqueous phase from the organic phase. This re-extraction from organic solvents is very complex.

In an optional subsequent step 4, the aqueous phase is concentrated by evaporation (for example under vacuum at temperatures in the range of 30° C. to 50° C.) and cesium is obtained in the form of solid cesium salts that can undergo further purification and processing. The salts can preferably be converted to anhydrous salts at temperatures in the range of 80° C. to 100° C. (for example at 90° C.) in a vacuum. Particularly preferred are cesium sulfate or cesium chloride, which—in anhydrous form—can be used in medicine directly for the production of cesium-137 radiation sources following the characterization and activity measurement.

The technetium dioxide filtered off is cleaned of adhering cesium salt and dried. It can be converted to its anhydrous form in a vacuum at elevated temperatures (greater than 200° C., e.g. at 300° C.). The powdery anhydrous technetium dioxide can then be pressed into pellets and, e.g., sent for transmutation in the reactor or released into a nuclear repository.

The method according to the invention has the following advantages in particular compared to conventional methods from the prior art:

The separation of cesium pertechnetate makes it possible to minimize the entry of cesium pertechnetate into the exhaust system of vitrification plants and therefore solves a longstanding technical problem of many vitrification plants. This makes it easier to maintain and operate running vitrification plants, and less radioactive residue remains in the exhaust system. The method according to the invention also allows dried or solid residue to be freed of, for example, HAWC or rinsing solutions of cesium pertechnetate. This makes the processing and final disposition of this waste more economical and environmentally friendly. Furthermore, the method according to the invention allows cesium isotopes to be put to economic use in the production of cesium radiation sources for medical or technical applications, since the cesium obtained is chemically pure (e.g., as anhydrous cesium sulfate or cesium chloride).

The method according to the invention also makes it possible to separate cesium isotopes and technetium isotopes from the other fission products of the nuclear fission of uranium and plutonium. As a result, the residual activity of the radioactive waste generated in the nuclear fission, and thus the amount of waste in the nuclear fission, is significantly reduced. Thus, up to 41% of the medium-term activity of waste from peaceful or military use of nuclear fission can be returned for commercial use. Finally, the method according to the invention also makes it possible to separate technetium-99, which represents up to 81% of the activity of the long-lived fission materials, from the radioactive waste (e.g. HAWC). The chemically stable, anhydrous technetium dioxide can either be made available for transmutation or, due to its water-insoluble properties, can be sent directly into deep geological rock formations for final disposition. The method is suitable for all cesium and technetium isotopes in the manner described. Overall, according to the invention, the ability to subject technetium-99 to final disposition is significantly improved, since technetium dioxide is chemically and thermally stable and water-insoluble and is not volatile under the expected ambient conditions. Further immobilization measures are therefore not required for final disposition.

The invention furthermore provides a device for separating cesium and technetium from radioactive waste. The device is preferably adapted to the method according to the invention and is suitable for carrying out the method according to the invention. This applies in particular to the embodiment for implementation in the exhaust gas flow of a vitrification plant. The device according to the invention makes it possible to obtain and isolate cesium pertechnetate, in pure form, that is either disposed in gaseous form in the exhaust gas flow of a vitrification plant or has been obtained using sublimation from dry residues from reprocessing nuclear fuels or from the vitrification process or other residues from HAWC solutions. The crystalline cesium pertechnetate obtained can then be separated into the two elements cesium and technetium as described above in the method according to the invention.

The device according to the invention has a plurality of gas coolers (i.e. cooling zones/zone gas coolers) that in principle are commercially available and contain cooling fingers or cooling coils for separating sublimated cesium pertechnetate disposed therein. The gas coolers can be connected in parallel and/or in series, which results in gas cooling units. Two, three, four, five, or more gas coolers are preferably connected in series one after the other. A gas cooling unit with three gas coolers is particularly preferred. The device according to the invention is preferably connected upstream of the exhaust gas flow from a vitrification plant. In other words, the exhaust gases from a vitrification plant, which contain cesium pertechnetate in the gas phase, are introduced into the device according to the invention so that cesium pertechnetate can be deposited there in pure form and with high efficiency. A device according to the invention (gas cooling unit) is shown in FIG. 1. Very particularly preferred is a device in which two, three or four (preferably two) such gas cooling units are connected in parallel with one another in series.

The most preferred device according to the invention comprises two gas cooling units, each having three gas coolers (cooling zones) connected in series, the two gas cooling units being connected in parallel such that they can be used alternately a) for depositing cesium pertechnetate from the exhaust gas flow and b) for obtaining the deposited cesium pertechnetate, thus enabling continuous operation. “Alternating” is to be construed to mean that cesium pertechnetate from the exhaust gas flow is deposited in one of the two gas cooling units per time unit, while the cesium pertechnetate previously deposited in the other gas cooling unit is obtained there. After cleaning, the task of the two units is reversed, so that the method is carried out continuously overall without downtimes caused by obtaining/cleaning all of the cooling units. Such a particularly preferred device is shown in FIG. 2. This device is particularly suitable for use in the exhaust gas flow of a vitrification plant for obtaining crystalline cesium pertechnetate.

Preferred embodiments for obtaining cesium pertechnetate and its further processing, with separation of cesium and technetium, according to the inventive method and the inventive device are described in more detail below:

1. Integration of the Method According to the Invention in the Exhaust System of a Vitrification Plant

A system as indicated in FIG. 2 is used for this. The centerpiece is the gas cooling unit (zone gas cooler), shown in detail in FIG. 1, two of which are provided in the system. This gas cooling unit is connected to the exhaust air flange of the vitrification furnace (not shown) via valve V11 (V21). The connection between the exhaust air flange of the vitrification furnace and V11/V21 is thermally insulated and electrically heated to approximately 600° C. The system is designed redundantly. During operation, one cooler is operated while the other is being cleaned.

Operation is explained below using the gas cooling unit (zone gas cooler) WT 10. The WT 20 unit works analogously. When the gas cooling unit (zone gas cooler) WT 10 is in operation, the valves V11, V12 are open and the valves V13, V14 are closed. Exhaust gas from the vitrification furnace flows via the heated line via V11 from the furnace into the zone gas cooler WT 10 and is cooled incrementally on the cooling coils, i.e. in the lower region of the first cooling coil bundle, from approx. 600° C. to 500° C. at the upper edge of the first cooling coil, in the middle region from 500° C. to approx. 350° C. at the upper edge of the second bundle of cooling coils, and in the upper region to approx. 250° C. at the third bundle of cooling coils. During this process, cesium pertechnetate is deposited on the cooling coils in a pure (crystalline) form. Due to the temperature control, crystallization begins starting at the upper edge of the second bundle of cooling coils. Over the course of the second and third bundles, all of the cesium pertechnetate disposed in the exhaust air crystallizes out on the cooling coils. Since the diameter of the WT10 is reduced through continuous operation, pressure measurements P11 and P12 can determine a pressure difference P11-P12, starting from which the zone gas cooler is to be cleaned. Alternatively, it is possible to use the metering rate measured on the metering rate sensor DL1 to decide the time of cleaning of the zone gas cooler.

The valves V21 and V22 are opened for cleaning and the zone gas cooler WT 20 is put into operation. V11 is then closed. Now the cooler WT 10 is operated with coolant at 40° C. on all cooling coils. As soon as all cooling temperatures are stable at 40° C., the cooler WT 10 is filled with water as a solvent via V40 and V13 (a higher temperature up to 100° C. is possible and also increases the solubility of the pertechnetate, but care must be taken to ensure that the solution does not cool down during further processing so that cesium pertechnetate then precipitates again). The fill level can be checked using fill level sensor L1. The uppermost cooling coil bundle must also be completely covered with solvent. The crystallized cesium pertechnetate is dissolved from the cooling coils at approx. 40° C. using circulation with pump 1 via V13 and V14. The process can be monitored by sampling. The cesium pertechnetate is considered to be completely dissolved once no further increase in activity concentration can be found in the solution. WT 10 is then emptied via the valve V30. The resulting solution can be provided for further processing (i.e., the separation of cesium and technetium, as described below). The cooler WT 10 is again available for operation. Both coolers WT 10 and WT 20 are alternately operated and cleaned during the vitrification so that cesium pertechnetate can be continuously separated in aqueous solution during the vitrification process.

2. Application of the Method According to the Invention for Processing Solid Residues from Reprocessing or Vitrification, which Residues Primarily Comprise Radioactive Cesium-137-Pertechnetate-99

The method according to the invention is applied to residues that are disposed directly in a container. The method according to the invention can also be used for residues that result, e.g., from sandblasting or similar methods, while the cesium pertechnetate is detached from component surfaces, for example with blasting sand, and is collected in a collection container together or separately from the blasting material. These residues are collected in a specially constructed radiologically shielded container that can be heated externally (e.g., electrically), as shown in FIG. 3. This container has a vacuum-tight flange lid with a cooling finger. The container is closed in a vacuum-tight manner and a reduced pressure is applied via the lid connection. A pressure of 10⁻⁹ to 10⁻¹⁰ bar is preferably set (high vacuum). The residues are then heated to the sublimation temperature for the cesium pertechnetate at the respective pressure+50-100 K. Pure (crystalline) cesium pertechnetate is deposited on the cooling finger. The cooling finger temperature can be approximately 20° C. (return temperature of the cooling water).

Following sublimation, the system is cooled and then the container is ventilated, and the lid, with the cooling finger, is moved onto a shieldable container and screwed tightly with its flange. This container is already shielded or can be shielded for upcoming transport.

The cesium pertechnetate is dissolved with pure water at about 40° C. via the rinsing connection of the container and the connection of the lid. The solution is preferably circulated with a pump (connected on the pressure side to the lower container connection) via the connection in the lid. The dissolution process is considered to be complete when the cesium-137 activity in samples of the aqueous solution no longer increases. The aqueous cesium pertechnetate solution produced is separated off and sent for further processing (i.e., separation of cesium and technetium, as described below). The cleaned lid flange can be used for the next sublimation. The sublimated cesium pertechnetate produced in this way is chemically pure and can be further processed without any problem.

3. Processing of the Cesium Pertechnetate Solution/Separation of the Elements Technetium and Cesium

The resulting cesium pertechnetate solution is heated to a temperature between 30° C. and 40° C., and a 20% solution of hydrazine in water is added dropwise while stirring. Gray coloration develops, and a brown-black solid separates due to further addition of hydrazine solution.

The following reaction takes place:

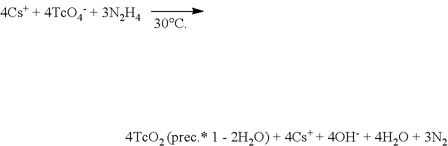

The hydrazine added by drops reacts with the pertechnetates to create technetium dioxide, which is insoluble in water and precipitates as a dihydrate. An aqueous cesium hydroxide solution remains. Careful metering of hydrazine continues until no more technetium dioxide precipitates. Upon complete reduction and completion of the metering, a hydrazine excess of 10 to 20 mg/kg should verifiably remain in the solution for 10 min at 30° C. to ensure the absence of pertechnetate. At the end of the reaction, the pH is in the alkaline range (greater than pH 8). The solution is then left to stand for about 1 hour so that the technetium dioxide dihydrate formed can settle. The precipitate is filtered off and washed with cold water until no significant cesium concentration can be measured in the precipitate using a gamma sensor measurement.

The technetium dioxide dihydrate that was filtered off can be dried and freed of crystallization water at 300° C. and reduced pressure:

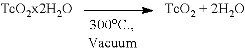

Technetium dioxide can then either be sent directly to final disposition or pressed into pellets and sintered into fuel rod-like structures for transmutation.

### Processing the Remaining Cesium:

The wash water and filtrate are combined and neutralized to pH 7 with a suitable acid. Suitable acids are inorganic acids, such as sulfuric acid, hydrochloric acid, and phosphoric acid. Hydrochloric acid, with which the reaction proceeds as follows, is particularly preferred:

CsOH+HCl→CsCl+H₂O

Neutralization produces cesium chloride, which can be crystallized by evaporating the water at 40° C. in a vacuum and can be dried at 90° C. in a vacuum to form the anhydrous salt. The anhydrous cesium chloride can be used as a starting material for medical radiators. Weighed out tablets compressed by means of a press can be used, e.g., in medical or technical radiation sources.

### Example

The example below further illustrates the method according to the invention:

1. Sublimation

A mixture of 5 g solid blasting material (e.g. garnet blasting sand) and 3.5 g cesium pertechnetate (CsTcO₄) is added to a sublimation apparatus and sublimated at a reduced pressure of approximately 8.5·10⁻⁵ mbar and 390° C. About 3.1 g pure white CsTcO₄ is deposited on the surface of the cooling finger in fine crystalline form. The product can be removed with 1 L distilled water at approx. 50° C. and, after concentration by evaporation in a vacuum at 60° C., provides about 3.1 g CsTcO₄. Alternatively, the sublimated CsTcO₄ can remain on the cooling finger and be used directly for the following reductive separation.

2. Reductive Separation

For reductive separation, 3.1 g CsTcO₄ is used, obtained either following concentration by evaporation from the sublimation or as a fine crystalline solid adhering to the cooling finger. 70 mL of a 20% aqueous hydrazine solution is added to the solid. While stirring, black technetium dioxide deposits as dihydrate (TcO₂.1-2 H₂O). The reaction is completed by careful concentration by evaporation. The moist crystal slurry obtained is taken up in distilled water and suctioned off through a 0.5 μm Teflon filter. The filter cake is washed with water until a desired residual cesium-137 activity in the filter cake is reached. The washed filter cake is dried on the filter and then removed mechanically. The TcO₂.1-2 H₂O obtained can be freed from crystallization water at 300° C. in a high vacuum.

The combined filtrates and eluates of the resulting cesium hydroxide solution are neutralized to pH 7 with dilute hydrochloric acid and then concentrated by evaporation in a vacuum. The precipitating cesium chloride is dried at 100° C. in a drying cabinet under vacuum to form the anhydrous salt.

1. A method for the separating cesium and technetium isotopes from mixtures of radioactive substances, characterized in that the method comprises the sublimation of cesium pertechnetate (CsTcO4).

2. The method according to claim 1, wherein the sublimation runs in the exhaust gas flow of a processing plant, including vitrification, sintering, drying, combustion, cementing or calcinating plants.

3. The method according to claim 1, wherein residues from the reprocessing of nuclear fuels or from the reprocessing plants or other residues from HAWC or rinsing solutions or other mixtures of substances are used as the starting material for the sublimation.

4. The method according to one of claim 1, wherein the sublimated cesium pertechnetate is deposited from the gas phase using consolidation and is then separated.

5. The method according to claim 4, wherein the consolidation takes place in one or more gas coolers that can be connected in parallel and/or in series.

6. The method according to claim 4, wherein the deposited cesium pertechnetate is separated from the apparatus used in situ or the apparatus used is transported to another location before the cesium pertechnetate is separated.

7. The method according to one of claim 4, wherein the cesium pertechnetate is separated by dissolving with an inorganic or organic solvent comprising water or mixtures thereof.

8. The method according to one of claim 1, wherein in a further step the cesium pertechnetate is reduced, during which reduction pertechnetate is converted to technetium dioxide, which is then separated off.

9. The method according to claim 8, wherein the reduction of cesium pertechnetate in aqueous solution occurs with a reducing agent selected from LiAlH4, NaBH4, alkali metal hydrides, hydrazine, carbon monoxide, formaldehyde, acetaldehyde, formic acid, or oxalic acid, and the technetium dioxide formed is separated off as a solid, while cesium remains in aqueous solution.

10. The method according to claim 9, wherein the aqueous solution is concentrated by evaporation and cesium is obtained in the form of solid cesium salts.

11. A device for separating cesium and technetium isotopes from mixtures of radioactive materials, characterized in that the device comprises a plurality of gas coolers that are connected in parallel and/or in series, and in that the device is suitable for integration into the exhaust gas flow of a processing plant, including vitrification, sintering, drying, combustion, cementing, or calcinating plants.

12. The device according to claim 11, characterized in that the device is integrated in the exhaust gas flow of the processing plant for separating cesium pertechnetate.

13. The device according to claim 12, characterized in that the device comprises at least two gas cooling units, each having at least three gas coolers connected in series, the at least two gas cooling units being connected in parallel.

14. The device according to claim 13, characterized in that the device comprises two gas cooling units, each having three gas coolers connected in series, the two gas cooling units being connected in parallel such that they are used alternately for depositing cesium pertechnetate from the exhaust gas flow and for obtaining the separated cesium pertechnetate, and thus allow continuous operation.
